(19) United States
(12) Patent Application Publication
(10) Pub. No.: US 2016/0001630 A1
(43) Pub. Date: Jan. 7, 2016

(54) AIR PASSAGE OPENING/CLOSING DEVICE

(71) Applicant: DENSO CORPORATION, Kariya-city, Aichi (JP)

(72) Inventors: Yuuichi NAKAO, Kariya-city (JP); Takayuki SHIMAUCHI, Kariya-city (JP)

(21) Appl. No.: 14/768,891

(22) PCT Filed: Jan. 27, 2014
(86) PCT No.: PCT/JP2014/000385

§ 371 Date: Aug. 19, 2015

(30) Foreign Application Priority Data
Feb. 20, 2013 (JP) 2013-031373

(51) Int. Cl. B60H 1/00

(52) U.S. Cl. CPC B60H 1/00692; B60H 1/00057

(57) ABSTRACT

An air passage opening and closing device includes: a sliding door configured to open and close an air passage using a plate-like portion disposed in an air-conditioning case; and a guide groove having a windward-side wall portion and a leeward-side wall portion. The plate-like portion includes: a first abutting portion positioned at an intermediate portion in a movement direction and abutting on the windward-side wall portion; two second abutting portions positioned on both sides of the first abutting portion in the movement direction and undergoing elastic deformation by abutting on one of the windward-side wall portion and the leeward-side wall portion; and two third abutting portions positioned on the both sides of the first abutting portion in the movement direction and pressed against and therefore abutting on the other wall portion on which the second abutting portions do not abut due to the elastic deformation of the second abutting portions.

### CROSS REFERENCE TO RELATED APPLICATION

This application is based on Japanese Patent Application No. 2013-31373 filed on Feb. 20, 2013, the disclosure of which is incorporated herein by reference.

### TECHNICAL FIELD

The present disclosure relates to an air passage opening/closing device that opens/closes an opening part of an air passage by a sliding door.

### BACKGROUND ART

An air passage opening and closing device disclosed in PTL 1 uses a flexible sliding door, which is one of components forming an air conditioner for a vehicle. A reaction force is conferred to the sliding door by setting a radius of curvature of the sliding door in a natural state to be greater than a radius of curvature of a guide groove of an air-conditioning case. A vibration-induced abnormal sound of the sliding door is thus prevented by holding the sliding door in the guide groove.

### PRIOR ART LITERATURES

### Patent Literature

PTL 1: JP 2010-000847A

### SUMMARY OF INVENTION

The radius of curvature of the guide groove may be increased for conforming a drive space of the sliding door to an outer wall of the air-conditioning case. However, when the radius of curvature of the guide groove is increased, a difference of the radii of curvature between the sliding door and the guide groove is reduced such that a reaction force of the guide groove relative to the sliding door is reduced. When the reaction force is reduced, the sliding door more readily vibrates in the guide groove due to vibrations of a vehicle. In short, increasing the radius of curvature may cause vibration-induced abnormal sound.

The present disclosure has an object to provide an air passage opening/closing device capable of restricting vibrations of a sliding door even when a radius of curvature of a guide groove is increased.

According to an aspect of the present disclosure, an air passage opening/closing device includes a sliding door and a guide groove. The sliding door has a plate-like portion disposed in a sliding movable manner in an air-conditioning case that defines an air passage in an interior, and is configured to open and close the air passage using the plate-like portion. The guide groove has a windward-side wall portion provided to the air-conditioning case on a more windward side than the plate-like portion so as to extend in a movement direction of the plate-like portion and a leeward-side wall portion provided to the air-conditioning case on a more leeward side than the plate-like portion so as to oppose the windward-side wall portion, and is configured to guide a movement of the plate-like portion using the windward-side wall portion and the leeward-side wall portion. The windward-side wall portion and the leeward-side wall portion are bowed to the leeward side. Radii of curvature of the windward-side wall portion and the leeward-side wall portion are set to be smaller than a radius of curvature of the plate-like portion in a state where no external force acts on the plate-like portion. The plate-like portion includes a first abutting portion positioned at an intermediate portion in the movement direction and abutting on the windward-side wall portion, two of second abutting portions positioned on both sides of the first abutting portion in the movement direction and undergoing elastic deformation by abutting on one of the windward-side wall portion and the leeward-side wall portion, and two of third abutting portions positioned on the both sides of the first abutting portion in the movement direction and pressed against and therefore abutting on the other wall portion on which the second abutting portions do not abut due to the elastic deformation of the second abutting portions.

The windward-side wall portion and the leeward-side wall portion are bowed to the leeward side and have radii of curvature set to be smaller than the radius of curvature of the plate-like portion in a state where no external force acts on the plate-like portion. The plate-like portion undergoes elastic deformation in which the first abutting portion abuts on the windward-side wall portion and the second abutting portions abut on the windward-side wall portion or the leeward-side wall portion. Due to the elastic deformation of the second abutting portions, the third abutting portions are pressed against and therefore abut on the other wall portion on which the second abutting portions do not abut. As described above, the second abutting portions do not merely abut on the windward-side wall portion or the leeward-side wall portion, but abut on one wall portion in an elastically deformed state. Because the second abutting portions are elastically deformed, the third abutting portions are pressed against the other wall portion by the restoring force. Hence, the plate-like portion is disposed in the guide groove in a more stable state than in a state where the second abutting portions and the third abutting portions merely abut on the windward-side wall portion and the leeward-side wall portion. In addition, the first abutting portion is positioned at the intermediate portion in the movement direction and the two second abutting portions and the two third abutting portions are positioned on the both sides of the first abutting portion in the movement direction. Hence, the plate-like portion is supported by the two second abutting portions, the two third abutting portions, and the first abutting portion. The plate-like portion is therefore supported in the guide groove in a stable manner. Owing to the configuration as above, even when the guide groove and the plate-like portion have large radii of curvature, vibrations of the sliding door can be restricted because the plate-like portion can be supported in the guide groove in a stable manner.

### BRIEF DESCRIPTION OF DRAWINGS

FIG. 1 is a sectional view of an indoor unit of a first embodiment when viewed in a vehicle right-left direction.

FIG. 2 is a view schematically showing an air mixing door having a small radius of curvature.

FIG. 3 is a view schematically showing an air mixing door having a large radius of curvature.

FIG. 4 is a side view showing a plate-like portion of the first embodiment.

FIG. 5 is a side view showing a state in which the plate-like portion is disposed in a guide groove.

FIG. 6 is a perspective view showing a part of a plate-like portion of a second embodiment.

FIG. 7 is an enlarged top view showing a part of the plate-like portion.

FIG. 8 is a sectional view taken along the line A-A of FIG. 7.

FIG. 9 is an enlarged top view showing a second abutting portion of a third embodiment.

FIG. 10 is a sectional view taken along the line B-B of FIG. 9.

FIG. 11 is an enlarged top view showing a second abutting portion of a fourth embodiment.

FIG. 12 is a sectional view taken along the line C-C of FIG. 11.

FIG. 13 is an enlarged top view showing a second abutting portion of a fifth embodiment.

FIG. 14 is a sectional view taken along the line D-D of FIG. 13.

FIG. 15 is an enlarged top view showing a second abutting portion of a sixth embodiment.

FIG. 16 is a sectional view taken along the line E-E of FIG. 15.

FIG. 17 is an enlarged top view showing a second abutting portion of a seventh embodiment.

FIG. 18 is a sectional view taken along the line F-F of FIG. 17.

### DESCRIPTION OF EMBODIMENTS

Embodiments of the present disclosure will be described hereafter referring to drawings. In the embodiments, a part that corresponds to a matter described in a preceding embodiment may be assigned with the same reference numeral or adding one letter to the preceding reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

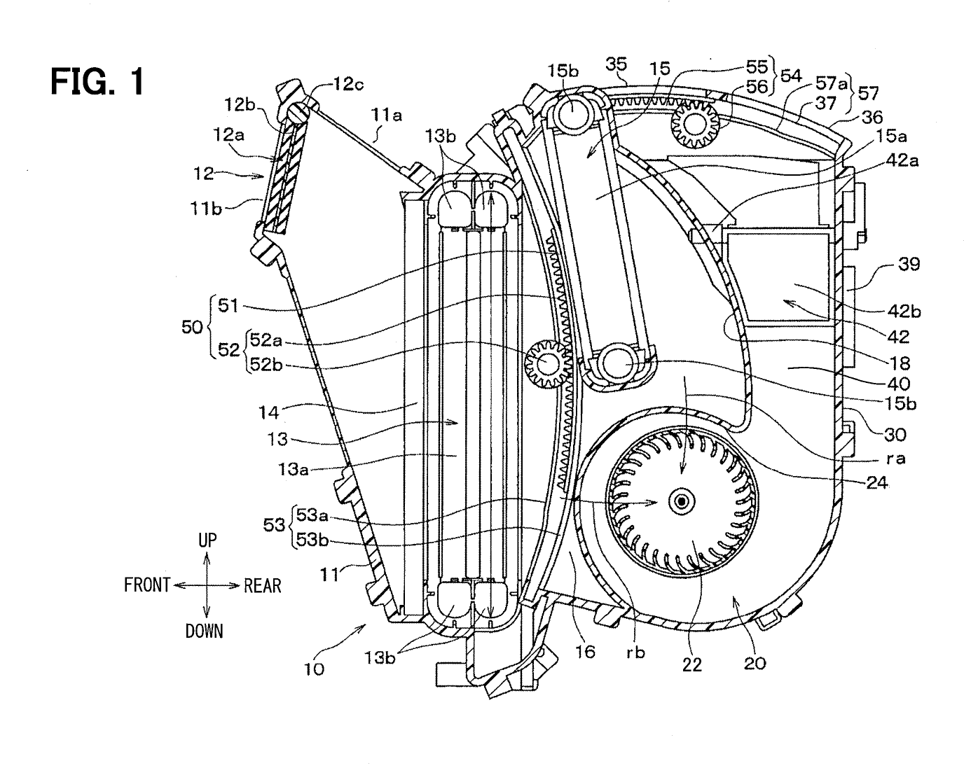

A first embodiment will be described with reference to FIG. 1 through FIG. 5. The present embodiment is a case where an air passage opening and closing device is applied to an air conditioner for a vehicle. Respective directions in a state where the air conditioner is mounted to a vehicle are indicated in the drawings by arrows pointing upward, downward, forward, rearward, rightward, and leftward.

An indoor unit 10 is installed substantially at a center in a vehicle right-left direction (vehicle width direction) in an inner back of an instrumental panel located in a foremost portion of a vehicle interior. The indoor unit 10 has an air-conditioning case 11 which forms an outer shell and also defines an air passage of air-conditioning air sent toward the vehicle interior. The air-conditioning case 11 is molded from resin (for example, polypropylene) having reasonable elasticity and excellent strength.

Further, the air-conditioning case 11 has a dividing surface extending in a vehicle up-down direction substantially at the center in the vehicle right-left direction. The air-conditioning case 11 is divided by the dividing surface to two casing portions in the right and left. The two casing portions in the right and left store respective components described below, such as an air filter 14, an evaporator 13, and a heater core 15, and are integrally coupled to each other by fastening member such as metal spring, clip, or screw.

As shown in FIG. 1, an inside and outside air switching portion 12 is provided at most upstream in the air passage defined by the air conditioning case 11 on a vehicle upper-front side of the air-conditioning case 11, and introduces inside air (air in the vehicle interior) or/and outside air (air out of the vehicle interior). The inside and outside air switching portion 12 is provided with an inside air introducing port 11a through which inside air is introduced into the air-conditioning case 11 and an outside air introducing port 11b through which outside air is introduced into the air-conditioning case 11.

In an interior of the inside and outside air switching portion 12, an inside and outside air switching door 12a is disposed in a rotatable manner and switched to open and close the inside air introducing port 11a and the outside air introducing port 11b. More specifically, the inside and outside air switching door 12a is so-called a cantilever door formed by integrally coupling a rotary shaft 12c extending in the vehicle right-left direction to one end of a plate-like base portion 12b.

The inside and outside air switching portion 12 is configured in such a manner that the base portion 12b is allowed to undergo rotary displacement by rotating the rotary shaft 12c with an unillustrated actuator, such as a servo motor, and is thereby capable of continuously changing an opening ratio of the inside air introducing port 11a and the outside air introducing port 11b. The evaporator 13 is disposed downstream of the inside and outside air switching portion 12 in a flow of air.

The evaporator 13 is one of devices forming an unillustrated known vapor compression refrigeration cycle and serves as a cooling heat exchanger that cools air-conditioning air through an endothermic action by evaporating low-pressure refrigerant in the refrigeration cycle. The evaporator 13 is formed by disposing tank portions 13b at both upper and lower ends of a core portion 13a made up of multiple tubes and heat-exchanging fins and is of a flat shape as a whole. The evaporator 13 is disposed with a flat ventilation surface facing in a vehicle front-rear direction.

The multiple tubes of the evaporator 13 are aligned parallel to one another in the right-left direction and the refrigerant flows each tube. The heat-exchanging fins facilitate exchange of heat between the refrigerant in the tubes and the air-conditioning air outside the tubes. The respective tank portions 13b are disposed above and below the multiple tubes to distribute the refrigerant to the multiple tubes and collect the refrigerant from the multiple tubes. The evaporator 13 is supported on the air-conditioning case 11 by the upper and lower tank portions 13b.

In the interior of the air-conditioning case 11, the air filter 14 shaped like a thin plate is disposed upstream of the evaporator 13 in the air current. The air filter 14 removes dust and the like from air that flows into the evaporator 13. A heater core 15 is disposed downstream of the evaporator 13 in the air current on the vehicle upper-rear side. The heater core 15 is a heating heat exchanger that heats cold air cooled in the evaporator 13 again through exchange of heat between a hot engine coolant circulating inside an unillustrated engine coolant circuit and the cold air.

As with the evaporator 13, the heater core 15 is formed by disposing tank portions 15b to upper and lower ends of a core portion 15a made up of multiple tubes and heat-exchanging fins, and is of a flat shape as a whole. The heater core 15 is disposed substantially parallel to the evaporator 13. In the present embodiment, the heater core 15 is disposed in such a manner that a flat surface of the heater core 15 inclines at a predetermined angle (approximately 10 degrees) with respect to the flat surface of the evaporator 13 for an upper end of the heater core 15 to be positioned slightly on the front side than a lower end of the heater core 15.

The multiple tubes of the heater core 15 are aligned parallel to one another substantially in the up-down direction along the inclination angle of the heater core 15. The upper tank portion 15b distributes the engine coolant to the multiple tubes while the lower tank portion 15b collects the engine coolant from the multiple tubes. The heater core 15 is supported on the air-conditioning case 11 by the upper and lower tank portions 15b.

A bypass passage 16 is formed behind the evaporator 13 and below the heater core 15. The bypass passage 16 is a passage which the cold air that has passed through the evaporator 13 flows by detouring around the heater core 15. An air mixing door 50 is disposed immediately after the evaporator 13, and adjusts an air volume ratio of cold air to be flowed toward the heater core 15 and cold air to be flowed toward the bypass passage 16.

The air mixing door 50 is made from a sliding door having a flexible plate-like portion 51 and a gear mechanism 52. The plate-like portion 51 is made of resin, shaped like a plate, and extends in the up-down direction while bending in an arc shape toward the vehicle rear side. The gear mechanism 52 drives the plate-like portion 51 to undergo displacement in the vehicle up-down direction. The plate-like portion 51 of the air mixing door 50 is movable by sliding. By sliding the plate-like portion 51 toward the vehicle upper side, a passage opening degree on the side of the bypass passage 16 is increased while a passage opening degree on the side of the heater core 15 is decreased.

Conversely, by sliding the plate-like portion 51 toward the vehicle lower side, a passage opening degree on the side of the bypass passage 16 is decreased while a passage opening degree on the side of the heater core 15 is increased. In response to the adjustment of the opening degree by the air mixing door 50, an air volume ratio of cold air and hot air to be sucked into an air blower 20 described below is adjusted and consequently a temperature of air-conditioning air sent from the air blower 20 to the vehicle interior is adjusted. In short, the air mixing door 50 constitutes conditioned air temperature adjusting unit.

The gear mechanism 52 has a rack 52a provided to the plate-like portion 51 so as to extend in the sliding direction of the plate-like portion 51 and a pinion 52b meshed with the rack 52a. The pinion 52b is driven by an unillustrated actuator, such as a servo motor. In the present embodiment, the rack 52a and the pinion 52b are disposed on a windward side of the plate-like portion 51.

Also, the rack 52a and the pinion 52b are disposed in the vicinity of either end of the plate-like portion 51 in the width direction (sheet thickness direction of FIG. 1). More specifically, the racks 52a and the pinions 52b are disposed on an inner side in the width direction than the both ends of the plate-like portion 51 in the width direction. The air-conditioning case 11 is provided with a guide groove 53 that guides sliding motion of the plate-like portion 51. The guide groove 53 is disposed on either side of the plate-like portion 51 in the width direction.

Each guide groove 53 has a windward-side wall portion 53a provided on a more windward side than the plate-like portion 51 and extending in a sliding direction (movement direction) of the plate-like portion 51, and a leeward-side wall portion 53b provided on a more leeward side than the plate-like portion 51 and opposing the windward-side wall portion 53a. The both ends of the plate-like portion 51 in the width direction, that is, regions of the plate-like portion 51 on an outer side than the racks 52a in the width direction, are inserted in respective spaces between the windward-side wall portions 53a and the leeward-side wall portions 53b in a slidable manner. Accordingly, the plate-like portion 51 is guided by the guide grooves 53 each formed of the windward-side wall portion 53a and the leeward-side wall portion 53b.

In the interior of the air-conditioning case 11, the air blower 20 is disposed below the heater core 15. As is shown in FIG. 1, the air blower 20 includes an electric motor 21, a fan 22, and a scroll casing 24. The electric motor 21 is disposed in the interior of the air-conditioning case 11 at the center in the vehicle right-left direction and a rotation shaft of the electric motor 21 extends to both sides in the vehicle right-left direction.

The fan 22 is a centrifugal multi-blade fan (sirocco fan) and the fan 22 is fixed to the rotation shaft of the electric motor 21 at a left tip end. The fan 22 has a large number of blades aligned along a rotation shaft and sucks in air from the outside in an axial direction and blows out air to the outside in a radial direction.

The scroll casing 24 stores the fan 22 and defines a flow-out air passage in which air flowing out from the fan 22 passes through. In the scroll casing 24, a passage sectional area of the flow-out air passage is provided in a spiral shape that gradually expands in a rotational direction of the fan 22. The scroll casing 24 also includes inlet ports provided on both sides in the rotation axis direction and an outlet port from which to blow out blast air blown out from the fan 22 to the upper side.

As is shown in FIG. 1, a curve-shaped partition wall 18 is provided in the interior of the air-conditioning case 11 on the vehicle rear side of the heater core 15. The partition wall 18 constitutes a guide wall that guides hot air blown out from the heater core 15 toward the air blower 20. An air passage 40 is provided between the partition wall 18 and a rear wall (outer wall) 30 to introduce blast air blown out from the scroll casing 24 to a defroster opening 35 and a face opening 36.

The face opening 36 is provided to an upper surface of the air-conditioning case 11 in a region on the vehicle rear side and serves as an opening through which to blow out an air current flowing the air passage 40 toward the head and the chest of an occupant seated on a front seat in the vehicle interior. The defroster opening 35 is disposed to the upper surface of the air-conditioning case 11 more on the vehicle front side than the face opening 36 and serves as an opening through which to blow out an air current flowing the air passage 40 toward an inner surface of a vehicle windshield.

A defroster-face door 54, which is one of blow-out mode doors, is disposed on the inner side of the openings 35 and 36 of the air-conditioning case 11. As with the air mixing door 50, the defroster-face door 54 is also a sliding door. Hence, the defroster-face door 54 has a flexible plate-like portion 55 and a gear mechanism 56. The plate-like portion 55 is made of resin, shaped like a plate, and extends in the vehicle front-rear direction while bending upward in an arc shape. The gear mechanism 56 drives the plate-like portion 55 to undergo displacement in the vehicle front-rear direction. By sliding the plate-like portion 55 of the defroster-face door 54 toward the vehicle front side, a passage opening degree on the side of the opening 36 is increased while a passage opening degree on the side of the opening 35 is decreased.

Conversely, by sliding the plate-like portion 55 toward the vehicle rear side, a passage opening degree on the side of the opening 35 is increased while a passage opening degree on the side of the opening 36 is decreased. As with the gear mechanism 52 of the air mixing door 50, the gear mechanism 56 of the defroster-face door 54 has racks and pinions. Each guide groove 57 that guides sliding motion of the plate-like portion 55 of the defroster-face door 54 has a case-side seal surface 37 positioned more on the leeward side than the plate-like portion 55 and a windward-side wall portion 57a provided more on the windward side than the plate-like portion 55 and opposing the case-side seal surface 37.

As is shown in FIG. 1, the rear wall 30 of the air-conditioning case 11 has back-seat-side foot openings 39. An air current flowing the air passage 40 is blown out through the back-seat-side foot openings 39 toward the feet of occupants seated on back seats. The air-conditioning case 11 is also provided with front-seat-side foot openings (not shown). An air current flowing the air passage 40 is blown out through the front-seat-side foot openings toward the feet of occupants seated on the front seats.

A foot door 42 is disposed to the air-conditioning case 11 on the inner side of each foot opening 39. The foot door 42 is so-called a butterfly door formed by providing a rotary shaft 42a extending in the vehicle front-rear direction at a center of a plate-like base portion 42b as an integral part. An opening ratio of the both foot openings 39 can be changed by allowing the base portion 42b to undergo rotary displacement by rotating the rotary shaft 42a with an unillustrated actuator, such as a servo motor.

An operation of the indoor unit 10 of the present embodiment will now be described. Firstly, the electric motor 21 of the air blower 20 drives the fan 22 to rotate. The fan 22 sucks in air from the both inlet ports of the scroll casing 24 and blows out air from the outlet port of the scroll casing 24. By the operation of the air blower 20, air is introduced into the air-conditioning case 11 through at least one of the inside air introducing port 11a and the outside air introducing port 11b. The introduced blast air passes through the air filter 14 and flows into the evaporator 13. The blast air exchanges heat with the refrigerant while passing through the evaporator 13 and is thus cooled and turned to cold air.

In a case where the air mixing door 50 opens both of the air inlet side of the bypass passage 16 and the air inlet side of the heater core 15, a part of the cold air blown out from the evaporator 13 flows toward the heater core 15 and is heated by the heater core 15. Consequently, the part of the cold air is blown out from the heater core 15 as hot air. The hot air is guided by the partition wall 18 toward the air blower 20 and flows as indicated by an arrow ra of FIG. 1. The rest of the cold air blown out from the evaporator 13 passes through the bypass passage 16 and flows as indicated by an arrow rb of FIG. 1.

In association with the flows indicated above, the cold air that has passed through the bypass passage 16 and the hot air that is blown out from the heater core 15 flow toward the both inlet ports of the scroll casing 24. The cold air and the hot air collide with each other at an angle of about 90 degrees before the both are sucked into the inlet ports. The cold air and the hot air that have collided with each other as described above before being sucked by the scroll casing 24 are sucked in by an operation of the fan 22 and blown out in the radial direction. Consequently, the cold air and the hot air that have collided with each other are mixed with each other to form conditioned air, which is blown out in the radial direction. The conditioned air subsequently passes along the scroll casing 24 and is blown out to the air passage 40. The conditioned air that has been blown out passes through the air passage 40 and is blown out toward the vehicle interior through either the face opening 36 or the foot openings 39.

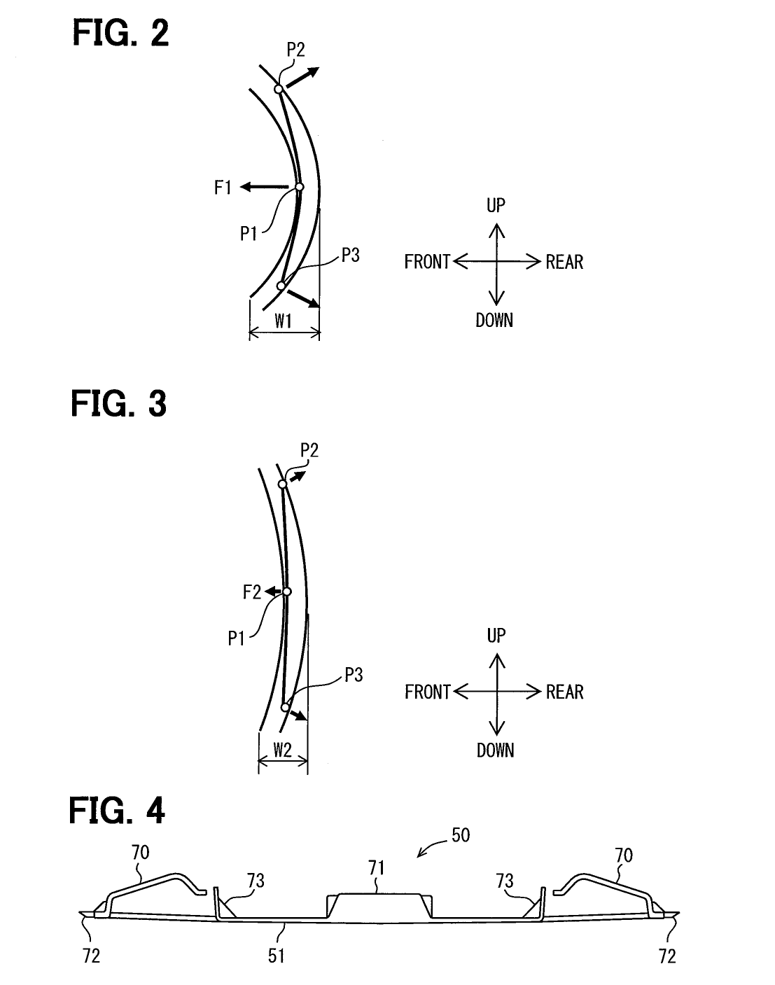

A configuration of the air mixing door 50 will now be described more in detail with reference to FIG. 2 through FIG. 5. FIG. 3 is a view schematically showing the air mixing door 50 and the guide groove 53 when the radius of curvature is large. For ease of illustration, the plate-like portion 51 of the air mixing door 50 is indicated by a thick line and the gear mechanism 52 is omitted in FIG. 2 and FIG. 3. The windward-side wall portion 53a and the leeward-side wall portion 53b that together form each guide groove 53 are bowed to the leeward side. Radii of curvature of the windward-side wall portion 53a and the leeward-side wall portion 53b are equal to each other.

The radius of curvature of the plate-like portion 51 of the air mixing door 50 in a natural state (a free state in the absence of an external force and restrictions) before the air mixing door 50 is fit to the guide grooves 53 is set to be greater than the radius of curvature of the windward-side wall portion 53a and the radius of curvature of the leeward-side wall portion 53b that together form the guide groove 53. When the air mixing door 50 is fit to the guide grooves 53, an intermediate portion of the plate-like portion 51 in the movement direction abuts on the windward-side wall portion 53a at an abutting point P1 while both ends of the plate-like portion 51 in the movement direction abut on the leeward-side wall portion 53b at abutting points P2 and P3. The plate-like portion 51 therefore elastically undergoes bending deformation and generates elastic restoring force F1, F2 to bring the plate-like portion 51 back to a free state at the respective abutting points P1 through P3. The plate-like portion 51 is thus pressed against the windward-side wall portion 53a and the leeward-side wall portion 53b by the elastic restoring force F1, F2.

A comparison between FIG. 2 and FIG. 3 reveals that a degree of bending deformation of the plate-like portion 51 of FIG. 3, which shows a state when the radius of curvature is large, becomes small due to the large radius of curvature. Hence, when the radius of curvature is large, the elastic restoring force F2 becomes small. When the elastic restoring force F2 is small, in a case where the entire indoor air conditioning unit 10 vibrates while no wind pressure is applied to the plate-like portion 51, the both ends of the plate-like portion 51 in the movement direction vibrate and may possibly generate an abnormal sound (chattering noise).

Also, a comparison between FIG. 2 and FIG. 3 reveals that a dimension W2 of the guide groove 53 in the right-left direction of FIG. 3, which shows a state when the radius of curvature is large, is smaller than a dimension W1 in the right-left direction of FIG. 2. Hence, when the dimension W in the right-left direction is reduced, the elastic restoring force F2 becomes small as described above.

In view of the foregoing, as is shown in FIG. 4, the plate-like portion 51 of the present embodiment is provided with partly elastic deformable second abutting portions 70 at the both ends in the movement direction. The plate-like portion 51 is also provided with a first abutting portion 71 at an intermediate portion in the movement direction. More specifically, the first abutting portion 71 is provided at a position including the center in the movement direction. The phrase, “the position including the center”, referred to herein means not only a configuration in which the center of the first abutting portion 71 in the movement direction and the center of the plate-like portion 51 in the movement direction coincide with each other, but also a position at which any part of the first abutting portion 71 overlaps with the center of the plate-like portion 51. The first abutting portion 71 protrudes toward the windward-side wall portion 53a from a surface of the plate-like portion 51 opposing the windward-side wall portion 53a. The first abutting portion 71 is integrally molded with the plate-like portion 51 and has rigidity.

The second abutting portions 70 protrude toward the windward-side wall portion 53a from the surface of the plate-like portion 51 opposing the windward-side wall portion 53a, and the protruding portions are elastically deformable. The second abutting portions 70 undergo elastic deformation when abutting on the windward-side wall portion 53a, which is one of the wall portions. The second abutting portions 70 protrude diagonally toward the center from the surface of the plate-like portion 51 and are integrally molded with the plate-like portion 51. Assume that the second abutting portions 70 are cantilever beams. Then, like a tip end of the cantilever beam undergoes displacement, a tip end of the second abutting portion 70 is allowed to be displaced toward the surface of the plate-like portion 51. Hence, the tip end of the second abutting portion 70 is elastically deformed in a thickness direction of the plate-like portion 51.

The plate-like portion 51 also has third abutting portions 72. The third abutting portions 72 are positioned on both sides of the first abutting portion 71 in the movement direction. Due to elastic deformation of the second abutting portions 70, the third abutting portions 72 are pressed against and therefore abut on the leeward-side wall portion 53b, which is the other one of the wall portions on which the second abutting portions 70 do not abut. The third abutting portions 72 have rigidity and are integrally molded with the plate-like portion 51.

The plate-like portion 51 further has a guard portion 73 protruding in the vicinity of the respective second abutting portions 70. The guard portion 73 is integrally molded with the plate-like portion 51 and have rigidity. Each guard portion 73 covers at least a part of the surface of the corresponding second abutting portion 70 on the side where the second abutting portion 70 is elastically deformed and hence the tip end of the second abutting portion 70 is displaced with respect to the root portion of the second abutting portion 70. When viewed from the tip end of the second abutting portion 70, the guard portion 73 is positioned on the opposite side to the root portion of the second abutting portion 70 and covers at least a part of a region from the root portion of the second abutting portion 70 to the tip end of the second abutting portion 70. More specifically, the tip end of the guard portion 73 is positioned in the vicinity of the tip end of the second abutting portion 70. The tip end of the guard portion 73 is at a position more distant from the surface of the plate-like portion 51 than the tip end of the second abutting portion 70 is. Hence, when viewed in the movement direction, the guard portions 73 cover the tip ends of the corresponding second abutting portions 70. Owing to the configuration as above, the guard portion 73 can restrict the tip end of the second abutting portion 70 from being hooked to the windward-side wall portion 53a during sliding motion. Damage on the second abutting portions 70 can be thus prevented.

The plate-like portion 51 of the present embodiment has the first abutting portion 71 at the center and the second abutting portions 70 at the both ends. Hence, when the entire plate-like portion 51 is viewed, the plate-like portion 51 is of a plane-symmetrical shape with respect to one virtual plane that includes the center in the movement direction and is orthogonal to the movement direction. The configuration as above can set a fitting direction free when the plate-like portion 51 is fit.

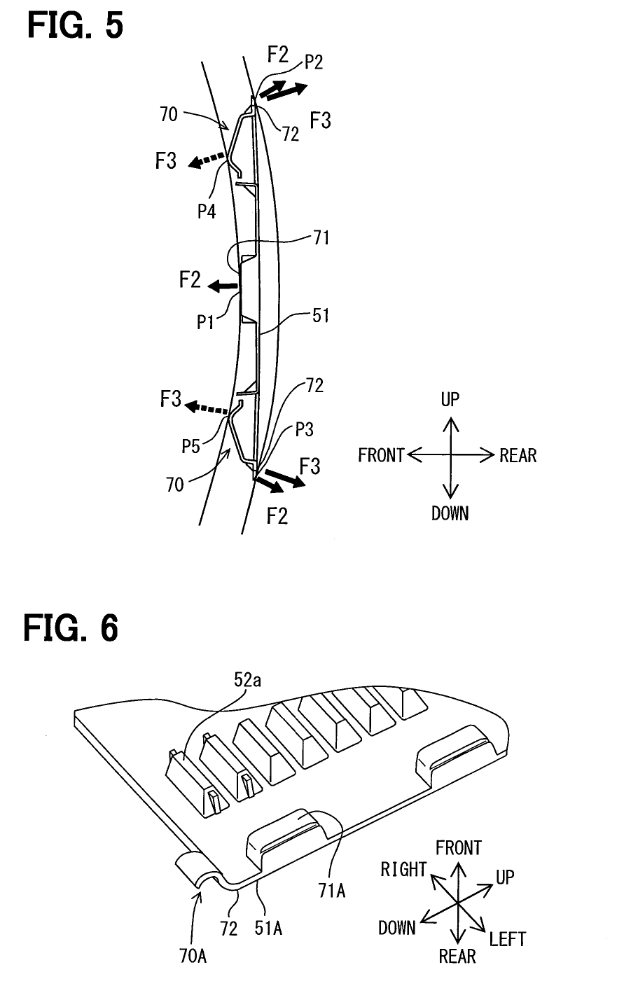

A state in which the plate-like portion 51 is disposed in the guide groove 53 will now be described with reference to FIG. 5. As is shown in FIG. 5, the two second abutting portions 70 are positioned on the both sides of the first abutting portion 71 in the movement direction. The two third abutting portions 72 are also positioned on the both sides of the first abutting portion 71 in the movement direction. In a state where the plate-like portion 51 is disposed in the guide groove 53, the first abutting portion 71 of the plate-like portion 51 abuts on (comes in contact with) the windward-side wall portion 53a at the abutting point P1. Further, the third abutting portions 72 of the plate-like portion 51 abut on the leeward-side wall portion 53b at the abutting points P2 and P3. Meanwhile, the second abutting portions 70 of the plate-like portion 51 abut on the windward-side wall portion 53a at abutting points P4 and P5. Accordingly, while the entire plate-like portion 51 is elastically deformed, the second abutting portions 70 is elastically deformed by abutting on the windward-side wall portion 53a to press the third abutting portions 72 against the leeward-side wall portion 53b.

Because the second abutting portions 70 are elastically deformed, elastic forces of the second abutting portions 70 act at the abutting points P4 and P5 of the windward-side wall portion 53a. Hence, reactive forces of the second abutting portions 70 also act at the abutting points P2 and P3 of the leeward-side wall portion 53b. Also, because the first abutting portion 71 abuts on the windward-side wall portion 53a at the abutting point P1, elastic restoring forces F2 are generated at the respective abutting points P1 through P3 to bring the plate-like portion 51 back to a free state. Hence, in comparison with the configuration of FIG. 3 in which the second abutting portions 70 are absent, elastic forces F3 of the second abutting portions 70 additionally act on the plate-like portion 51. The plate-like portion 51 is thus pressed against the windward-side wall portion 53a and the leeward-side wall portion 53b.

As has been described, the windward-side wall portion 53a and the leeward-side wall portion 53b of the present embodiment are bowed to the leeward side and have the radii of curvature set to be smaller than the radius of curvature of the plate-like portion 51 in a state where no external force acts on the plate-like portion 51. Of the plate-like portion 51, the first abutting portion 71 abuts on the windward-side wall portion 53a and the third abutting portions 72 abut on the leeward-side wall portion 53b and therefore the second abutting portions 70 undergo elastic deformation. As has been described, the second abutting portions 70 do not merely abut on the leeward-side wall portion 53b, but abut on the windward-side wall portion 53a in an elastically deformed state. In addition, due to the elastic deformation of the second abutting portions 70, the third abutting portions 72 are pressed against and therefore abut on the leeward-side wall portion 53b on which the second abutting portions 70 do not abut. Hence, the plate-like portion 51 is disposed in the guide grooves 53 in a more stable state than in a state where the third abutting portions 72 merely abut on the leeward-side wall portion 53b. In addition, the first abutting portion 71 is positioned at the intermediate portion in the movement direction and the two second abutting portions 70 and the two third abutting portions 72 are positioned on the both sides of the first abutting portion 71 in the movement direction. Hence, the plate-like portion 51 is supported at the two second abutting portions 70, the two third abutting portions 72, and the first abutting portion 71. The plate-like portion 51 is thus supported in the guide grooves 53 in a stable manner. Owing to the configuration as above, even when the guide grooves 53 and the plate-like portion 51 have large radii of curvature, vibrations of the sliding door can be restricted because the plate-like portion 51 can be supported in the guide grooves 53 in a stable manner.

In the present embodiment, the first abutting portion 71 is at a position including the center in the movement direction, and the third abutting portions 72 are positioned at the both ends in the movement direction. Hence, the plate-like portion 51 can be supported at the both ends and the intermediate portion in the movement direction. Accordingly, in a case where the entire indoor air conditioning unit 10 vibrates while no wind pressure is applied to the plate-like portion 51, generation of an abnormal sound (chattering noise) due to vibrations of the plate-like portion 51 at the both ends in the movement direction can be restricted.

In the present embodiment, the first abutting portion 71, the second abutting portions 70, and the third abutting portions 72 are integrally molded with the plate-like portion 51. Hence, the plate-like portion 51 can be molded easily.

In the present embodiment, the plate-like portion 51 has a plane-symmetrical shape with respect to one virtual plane including the center in the movement direction and orthogonal to the movement direction. Accordingly, a fitting direction of the plate-like portion 51 can be flexible. Hence, when the plate-like portion 51 is assembled into the guide grooves 53, it is not necessary to pay attention to an orientation of the plate-like portion 51. Consequently, assembling efficiency can be enhanced.

In the present embodiment, the second abutting portion 70 protrudes from the surface of the plate-like portion 51, and a part of the second abutting portion 70 abuts on the windward-side wall portion 53a, due to which another part of the second abutting portion 70 undergoes elastic deformation. Hence, a partly elastically deformable configuration can be achieved in a simple shape.

Also, the plate-like portion 51 further includes the guard portion 73 protruding from the surface of the plate-like portion 51 and covering at least a part of the second abutting portion 70 in a region from the root portion of the second abutting portion 70 to the tip end of the second abutting portion 70. The guard portion 73 covers at least a part of the surface of the second abutting portion 70 on the side where the second abutting portion 70 is elastically deformed and hence the tip end is displaced with respect to the root portion. The surface on the side where the displacement takes place is positioned on the center side of the plate-like portion 51 in the present embodiment. Hence, the guard portion 73 is positioned on the opposite side to the root portion of the second abutting portion 70 through the tip end of the second abutting portion 70. The second abutting portion 70 that is elastically deformable may break from the root when the tip end is pressed in the movement direction. However, by covering the tip end of the second abutting portion 70 with the guard portion 73 from the side where the displacement takes place, stress applied to the second abutting portion 70 in the movement direction in association with the movement of the plate-like plate 51 can be restricted. Consequently, damage on the second abutting portion 70 can be restricted.

In the present embodiment, the tip end of the guard portion 73 is at a position more distant from the surface of the plate-like portion 51 than the tip end of the second abutting portion 70 is. In other words, a distance from the tip end of the guard portion 73 to the surface of the plate-like portion 51 is longer than a distance from the tip end of the second abutting portion 70 to the surface of the plate-like portion 51. When configured as above, the tip end of the second abutting portion 70 can be covered by the guard portion 73 in a reliable manner. Stress in the movement direction can be thus prevented from acting on the tip end of the second abutting portion 70. Consequently, damage on the second abutting portion 70 can be restricted.

In the present embodiment, in the state where the plate-like portion 51 is disposed in the guide groove 53, the elastic force of the second abutting portion 70 is preferably set enough to prevent vibrations and enough to make the sliding resistance small at the abutting points P1 through P5 when the plate-like portion 51 is moved (displaced while in contact with the guide groove 53). Accordingly, vibrations can be restricted while a moving force of the plate-like portion 51 is controlled.

It is preferable that the plate-like portion 51 is pressed against the windward-side wall portion 53a and the leeward-side wall portion 53b not only in a particular operating position of the plate-like portion 51, but also across the entire operating range of the plate-like portion 51.

In the present embodiment, the guide grooves 53 are provided on the both sides of the plate-like portion 51 in the width direction. Hence, the plate-like portion 51 can be supported at three points on either side in the width direction. Consequently, vibrations of the plate-like portion 51 at the both ends in the movement direction can be restricted further and hence generation of an abnormal sound can be restricted further.

Although it is not shown in the drawings, in the blow-out mode door 54, which is configured in the same manner as the air mixing door 50, the plate-like portion 55 is supported at three points: the both ends and the intermediate portion in the movement direction. Hence, generation of an abnormal sound (chattering noise) due to vibrations of the plate-like portion 55 at the both ends in the movement direction can be restricted.

In short, it can be summarized that the second abutting portion 70 and the third abutting portion 72 are provided at the both ends of the plate-like portion 51 in the present embodiment to compensate for insufficient reactive forces by restoring forces induced by elastic deformation of the second abutting portions 70, so that the plate-like portion 51 is pressed against the windward-side wall portion 53a and the leeward-side wall portion 53b. Because the forces are generated, the plate-like portion 51 has a force large enough to withstand against the vibrations and therefore a vibration-induced abnormal sound of the plate-like portion 51 can be prevented. The structure capable of restricting a vibration-induced abnormal sound can be thus achieved independently of whether the radius of curvature of the guide groove 53 of the air-conditioning case 11 is small or large and a drive space (W) of the plate-like portion 51 can be smaller. Consequently, the air-conditioning case 11 can be more compact.

### Second Embodiment

A second embodiment will be described with reference to FIG. 6 through FIG. 8. In the present embodiment, a configuration of second abutting portion 70A is different and more than one first abutting portion 71A is provided.

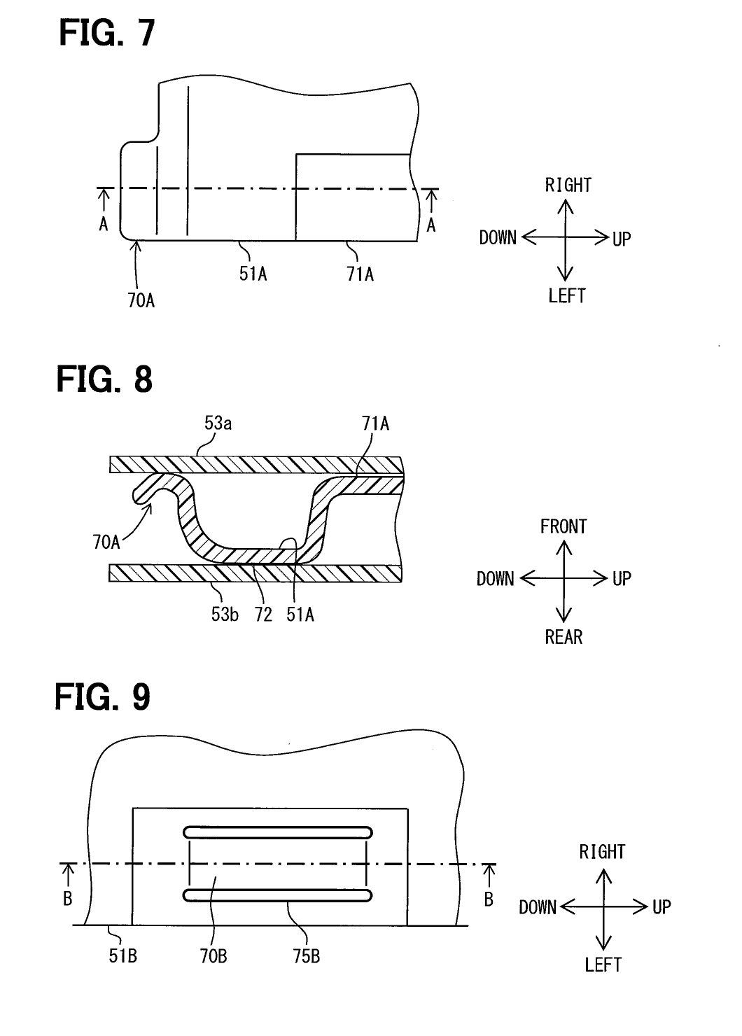

As are shown in FIG. 7 and FIG. 8, the second abutting portion 70A is provided at both ends of a plate-like portion 51A in an up-down direction and has a shape obtained by bending both ends in a right-left direction (width direction) like a capital S. Because the second abutting portion 70A is of a curved shape, the second abutting portion 70A is elastically deformable. In addition, multiple first abutting portions 71A are provided at intervals in the up-down direction. None of the first abutting portions 71A of the present embodiment is present at a position including a center in a movement direction. At least one of the multiple first abutting portions 71A abuts on a windward-side wall portion 53a.

The second abutting portion 70A configured as above can also achieve functions and advantageous effects same as those of the first embodiment described above. All of the multiple first abutting portions 71A do not necessarily abut on the windward-side wall portion 53a. When at least one first abutting portion 71A abuts on the windward-side wall portion 53a, the plate-like portion 51A can be supported at three points by the one first abutting portion 71A together with the two second abutting portions 70A. Hence, functions and advantageous effects same as those of the first embodiment described above can be achieved.

### Third Embodiment

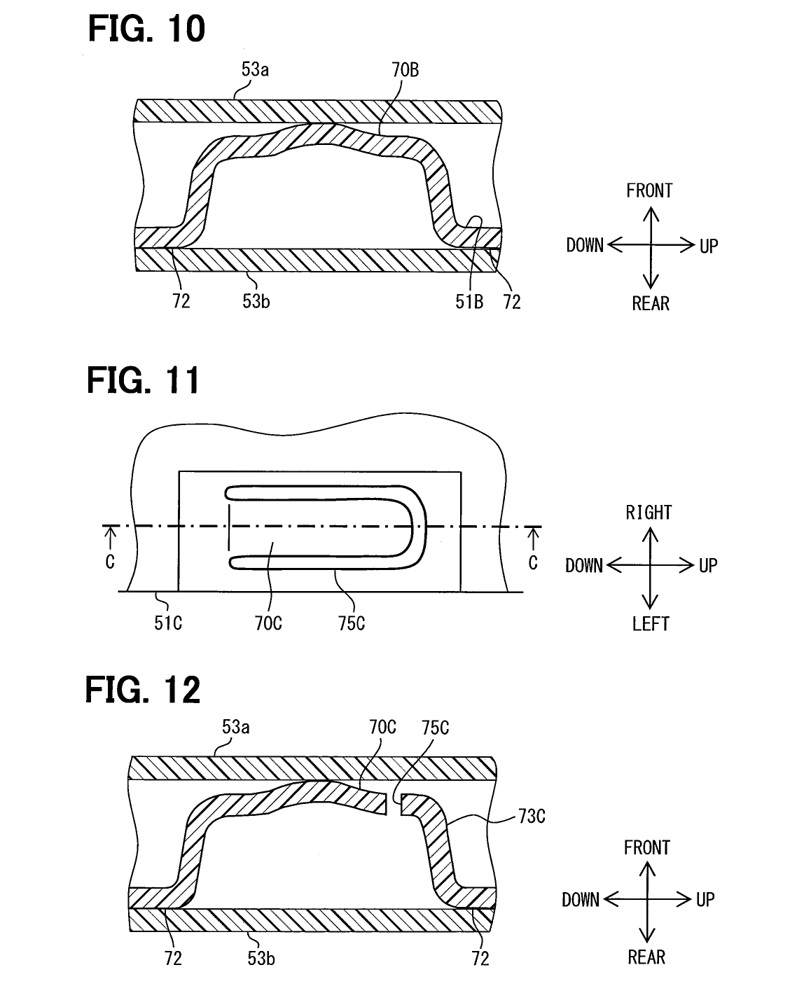

A third embodiment will be described with reference to FIG. 9 and FIG. 10. In the present embodiment, a configuration of second abutting portion 70B is different. As are shown in FIG. 9 and FIG. 10, each second abutting portion 70B protrudes from a surface of a plate-like portion 51B in the shape of an inverted capital U, and two slits 75B extending in an up-down direction and spaced apart in a right-left direction are provided at a top. The top positioned between the slits 75B is elastically deformable in a front-rear direction in FIG. 10. The second abutting portion 70B configured as above can also achieve functions and advantageous effects same as those of the first embodiment described above.

### Fourth Embodiment

A fourth embodiment will be described with reference to FIG. 11 and FIG. 12. In the present embodiment, a configuration of second abutting portion 70C is different. As are shown in FIG. 11 and FIG. 12, each second abutting portion 70C protrudes from a surface of a plate-like portion 51C in the shape of an inverted capital U and a U-shaped slit 75C extending in an up-down direction is provided at a top. The top surrounded by the slit 75C is elastically deformable in a front-rear direction of FIG. 12. The second abutting portion 70C configured as above can also achieve functions and advantageous effects same as those of the first embodiment described above. A portion divided from the second abutting portion 70C by the slit 75C forms a guard portion 73C which corresponds to the guard portion 73 of the first embodiment. A distance from a tip end of the guard portion 73C to the surface of the plate-like portion 51C is larger than or equal to a distance from a tip end of the second abutting portion 70C to the surface of the plate-like portion 51C.

### Fifth Embodiment

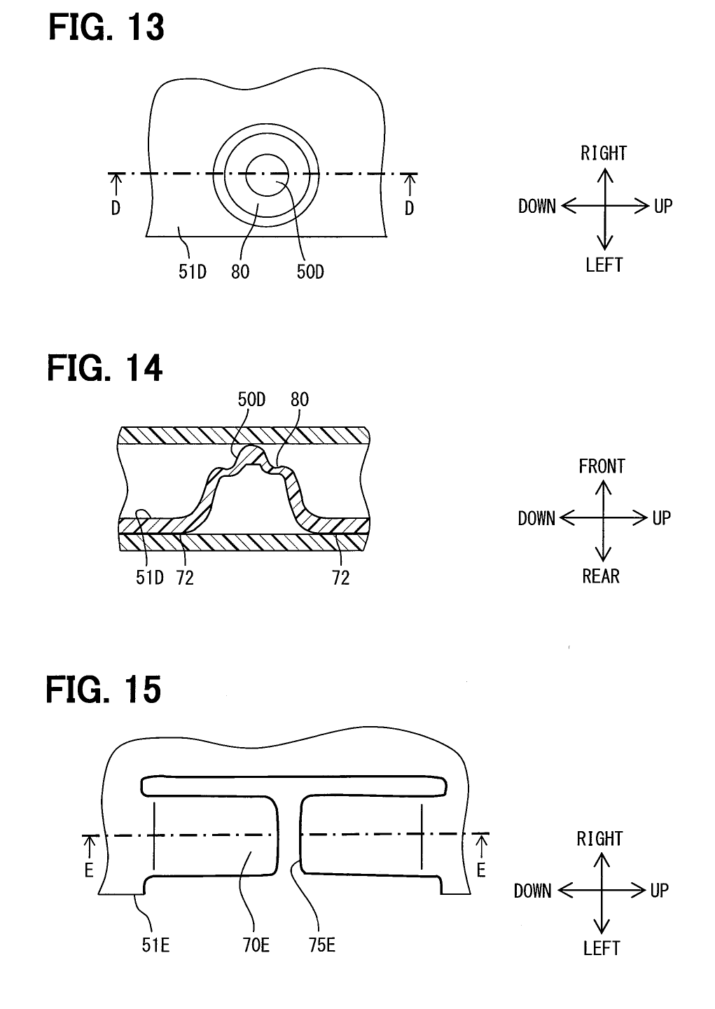

A fifth embodiment will be described with reference to FIG. 13 and FIG. 14. In the present embodiment, a configuration of second abutting portion 70D is different. As are shown in FIG. 13 and FIG. 14, each second abutting portion 70D is provided so as to protrude in a conical shape from a surface of a plate-like portion 51D while a part in a front-rear direction forms an annular shape in an up-down direction. An annular portion 80 is elastically deformable and a top is therefore elastically deformable in the front-rear direction of FIG. 14. The second abutting portion 70D configured as above can also achieve functions and advantageous effects same as those of the first embodiment described above.

### Sixth Embodiment

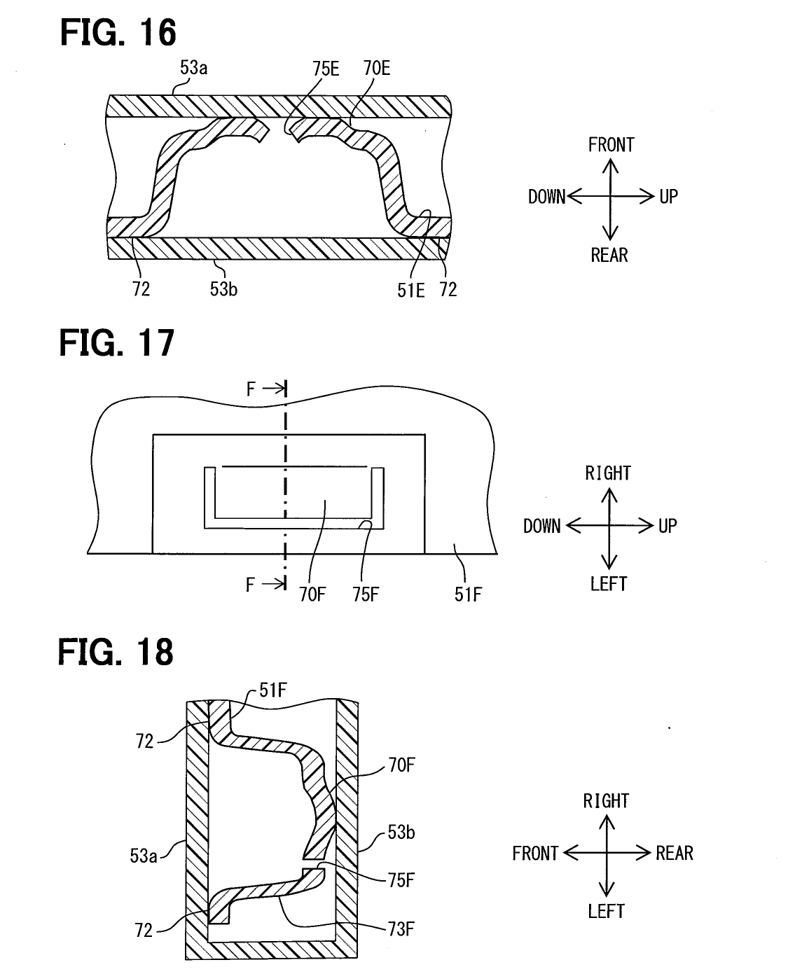

A sixth embodiment will be described with reference to FIG. 15 and FIG. 16. In the present embodiment, a configuration of second abutting portion 70E is different. As are shown in FIG. 15 and FIG. 16, each second abutting portion 70E protrudes from a surface of a plate-like portion 51E in the shape of an inverted capital U and an H-shaped slit 75E extending in an up-down direction is provided at a top. The top surrounded by the slit 75E is elastically deformable in a front-rear direction of FIG. 16. The second abutting portion 70E configured as above can also achieve functions and advantageous effects same as those of the first embodiment described above.

### Seventh Embodiment

A seventh embodiment will be described with reference to FIG. 17 and FIG. 18. In the present embodiment, a configuration of second abutting portion 70F is different. As are shown in FIG. 17 and FIG. 18, each second abutting portion 70F protrudes from a surface of a plate-like portion 51F in the shape of an inverted capital U and a U-shaped slit 75F extending in an up-down direction is provided at a top. The vertical direction of the shape U of the U-shaped slit 75F is defined to correspond to the right-left direction. The top surrounded by the slit 75F is elastically deformable in a front-rear direction of FIG. 18. The second abutting portion 70F configured as above can also achieve functions and advantageous effects same as those of the first embodiment described above. A portion divided from the second abutting portion 70F by the slit 75F forms a guard portion 73F which corresponds to the guard portion 73 of the first embodiment. A distance from a tip end of the guard portion 73F to the surface of the plate-like portion 51F is larger than or equal to a distance from a tip end of the second abutting portion 70F to the surface of the plate-like portion 51F.

### Other Embodiment

While preferred embodiments of the present disclosure have been described, it should be appreciated that the present disclosure is not limited to the embodiments described above and can be implemented in various modifications within the scope of the present disclosure.

Also, it should be understood that the structures of the embodiments above are only illustrative and the scope of the present disclosure is not limited to the scope of the description above. The scope of the present disclosure is determined by the scope of the appended claims. Further, the present disclosure includes meanings equivalent to descriptions in the scope of the appended claims and all changes within the scope of the appended claims.

In the first embodiment, the two second abutting portions 70 and the two third abutting portions 73 are provided. However, the number of each component is not limited to two and may be three or more. The third abutting portions 72 are positioned at the both ends of the plate-like portion 51. However, the third abutting portions 72 are not necessarily positioned at the both ends and can be provided at other positions as long as the third abutting portions 72 satisfy a positional relation that the third abutting portions 72 are disposed on the both sides of the first abutting portion 71. In other words, it is sufficient that a flexible sliding door is provided with a supporting structure formed by the guide grooves 53 and has the second abutting portions 70 that are constantly in contact with one wall portion and the third abutting portions 72 that are constantly in contact with the other wall portion.

In the first embodiment, the plate-like portion 51 is integrally molded with the respective abutting portions 70 through 72. It should be appreciated, however, that the foregoing components are not necessarily molded integrally. The respective abutting portions 70 through 72 may be formed separately and fit to the plate-like portion 51 in a re-attachable manner.

In the first embodiment, the plate-like portion 51 is of a plane-symmetrical shape with respect to one virtual plane including the center in the movement direction and orthogonal to the movement direction. It should be appreciated, however, that a shape of the plate-like portion 51 is not limited to the plane-symmetrical shape and the plate-like portion 51 may be of an asymmetric shape instead.

What is claimed is:

1. An air passage opening and closing device comprising:
a sliding door having a plate-like portion disposed in a sliding movable manner in an air-conditioning case that defines an air passage in an interior, and configured to open and close the air passage using the plate-like portion; and
a guide groove having a windward-side wall portion provided to the air-conditioning case on a more windward side than the plate-like portion so as to extend in a movement direction of the plate-like portion and a leeward-side wall portion provided to the air-conditioning case on a more leeward side than the plate-like portion so as to oppose the windward-side wall portion, and configured to guide a movement of the plate-like portion using the windward-side wall portion and the leeward-side wall portion, wherein:
the windward-side wall portion and the leeward-side wall portion are bowed to the leeward side;
radii of curvature of the windward-side wall portion and the leeward-side wall portion are set to be smaller than a radius of curvature of the plate-like portion in a state where no external force acts on the plate-like portion; and
the plate-like portion includes,
a first abutting portion positioned at an intermediate portion in the movement direction and abutting on the windward-side wall portion,
two of second abutting portions positioned on both sides of the first abutting portion in the movement direction and undergoing elastic deformation by abutting on one of the windward-side wall portion and the leeward-side wall portion, and
two of third abutting portions positioned on the both sides of the first abutting portion in the movement direction and pressed against and therefore abutting on the other wall portion on which the second abutting portions do not abut due to the elastic deformation of the second abutting portions.

2. The air passage opening and closing device according to claim 1, wherein:
the first abutting portion is at a position including a center of the plate-like portion in the movement direction; and
the third abutting portions are positioned on both ends of the plate-like portion in the movement direction.

3. The air passage opening and closing device according to claim 1, wherein:
the second abutting portion protrudes from a surface of the plate-like portion and a part of the second abutting portion abuts on the windward-side wall portion, due to which another part of the second abutting portion undergoes elastic deformation.

4. The air passage opening and closing device according to claim 1, wherein:
the first abutting portion, the second abutting portions, and the third abutting portions are integrally molded with the plate-like portion.

5. The air passage opening and closing device according to claim 1, wherein:
the plate-like portion is of a plane-symmetrical shape with respect to one virtual plane including the center in the movement direction and orthogonal to the movement direction.

6. The air passage opening and closing device according to claim 1, wherein:
the second abutting portion protrudes from a surface of the plate-like portion and a part of the second abutting portion abuts on the windward-side wall portion, due to which another part of the second abutting portion undergoes elastic deformation;
the plate-like portion further includes a guard portion protruding from the surface of the plate-like portion, and the guard portion is positioned on an opposite side to a root end of the second abutting portion through the tip end of the second abutting portion to cover at least a part of the second abutting portion.

7. The air passage opening and closing device according to claim 6, wherein:
a tip end of the guard portion is at a position more distant from the surface of the plate-like portion than the tip end of the second abutting portion is.
